(19) United States
(12) Patent Application Publication
(10) Pub. No.: US 2021/0167376 A1
(43) Pub. Date: Jun. 3, 2021

(54) 3D PRINTED BATTERY AND METHOD OF MAKING SAME

(71) Applicant: University College Cork - National University of Ireland, Cork, Cork (IE)

(72) Inventors: Colm O'Dwyer, Cork (IE); Colm Glynn, Cork (IE)

(73) Assignee: University College Cork - National University of Ireland, Cork, Cork (IE)

(21) Appl. No.: 16/630,037

(22) PCT Filed: Jul. 11, 2018
(86) PCT No.: PCT/EP2018/068849

§ 371 Date: Jan. 10, 2020

(30) Foreign Application Priority Data
Jul. 11, 2017 (GB) 1711147.7

(51) Int. Cl. H01M 4/525; H01M 4/62; H01M 10/04; H01M 4/505; H01M 4/133; H01M 4/66; H01M 4/1393; H01M 50/193

(52) U.S. Cl. CPC H01M 4/525; H01M 4/625; H01M 10/04; H01M 4/505; B33Y 10/00; H01M 4/663; H01M 4/1393; H01M 50/193; H01M 4/133

(57) ABSTRACT

The invention provides plastic 3D printed battery cell comprising a first layer coupled with a cathode material and a second layer coupled with an anode material. An aqueous electrolyte gel material is deposited onto the surface of the cathode material and the anode material, wherein the first and second layers are sealed to house the cathode material, the anode material and the electrolyte gel material. The invention provides a combination of a customisable plastic battery cell design using 3D printing with an all-in-one gel electrolyte enable the cells to be built in a variety of sizes and shapes allowing for greater integration of energy storage into electronic, medical or wearable systems. A method for making the 3D printed battery cell is also described.

### FIELD

The invention relates to the field of a 3D printed battery cell and a method of making such a battery.

### BACKGROUND

With the proliferation of smart electronics and the increased miniaturisation of these devices for modern internet of things (loT) and wearable applications, the development of alternative methods for battery construction to match the form factors of devices is becoming more important. Li-ion batteries have been the mainstay battery technology for smart and consumer electronics industries due to their high capacities, energy densities and cycle life performance.

New methods to improve performance and safety of Li-ion batteries are constantly being pursued, from developments of new electrode materials with higher capacities, to changes in the development of solid electrolytes. New battery chemistries are also being explored to boost performance, including Na-ion, Li-air and other cation-intercalation systems.

Changes to electrode materials can improve battery performance. For wearable, flexible, stretchable or small electronics applications, the size and shape of the resultant battery remains the same, with the batteries in modern electronics composing a large and bulky part of the overall volume and are always separate to the device they power. Battery designs incorporating flexible and stretchable electrodes/coatings demonstrate the state-of-the-art processes which can be combined for the customisation of modern devices. Examples of such designs are disclosed in Sun, H. et al. Energy harvesting and storage in 1D devices. Nat. Rev. Mats. 2, 17023 (2017); Wei, D. et al. Flexible solid state lithium batteries based on graphene inks. J. Mater. Chem. 21, 9762-9767 (2011); Gaikwad, A. M. et al. A High Areal Capacity Flexible Lithium-Ion Battery with a Strain-Compliant Design. Adv. Energy Mater. 5, 1401389-1401389 (2015); and Liu, W.; Song, M. S.; Kong, B.; Cui, Y. Flexible and Stretchable Energy Storage: Recent Advances and Future Perspectives. Adv. Mater. 29, (2017).

These designs however still rely upon the organic based electrolytes which are moisture sensitive and require anhydrous processing in their preparation. They are often limited in energy density (volumetric) as the flexibility typically arises from a very thin construction.

The development of aqueous Li-ion batteries, those which utilise a water based electrolyte and pre-lithiated electrodes, eliminates the need for high cost anhydrous processing methods, for example as disclosed in a paper by Kim, H. et al. Aqueous rechargeable Li and Na ion batteries. Chem. Rev. 114, 11788-11827 (2014). Aqueous based batteries do not require the use of costly and highly flammable organic electrolytes which must be monitored and controlled to is limit thermal runaway. As with organic Li-ion batteries, aqueous based cells can be adapted and used with a variety of electrode materials and morphologies. The cell voltages for aqueous based batteries are less than that of their organic counterparts, however, the benefits to safety and processing costs are driving future developments. Aqueous batteries can also be used to form flexible fibre electrodes which demonstrate high safety tolerances and stretching capabilities.

Current Li-ion technologies in any format, whether high capacity and high power, of limited capacity and long cycle life and variations of these, are not made with the end product design in mind. For remote wireless high density network products and body shape-conforming wearable technology or medical devices, current batteries cannot provide an effective solution because of their size and weight. Currently available lithium batteries have the desired low weight and high energy densities but they have limited lifetimes and have high self-discharge rates. They are mostly employed in power hungry devices such as mobile phones that require regular recharging. Existing battery design is restricted by the shape and the size of the device that it is powering. Examples of some printed battery devices are disclosed in U.S. Patent Publication No. US 2012/0015236; U.S. Pat. No. 8,599,572; U.S. Pat. No. 7,727,290 and U.S. Pat. No. 6,780,208, but none provide an effective solution to meet current industry demands.

International Patent Publication No. WO 2016/036607 describes a method for manufacturing a battery using 3D printing. This method involves creating a composite comprising a polymer matrix material in respect of each half cell and the electrolyte. Each composite is then processed by extrusion to form a filament. The two half cell filaments along with the electrolyte filament are then fed into a 3D printer and printed to form a battery. Thus this method only describes the making of two half cells separately, and then fusing the two half cells together by means of 3D printing.

International Patent Publication No. WO 2016/197006 describes a solid state battery where the anode, cathode and solid state electrolyte layer are fabricated is by 3D printing. However, solid state electrolytes are limited to use in flat battery cells. Furthermore, it will be appreciated that their ceramic formulation is not suitable for forming into complex battery shapes.

It is therefore an object to provide a 3D printed battery and a method of making such a battery to overcome the above mentioned problems.

### SUMMARY

According to the invention there is provided, as set out in the appended claims, a plastic 3D printed battery cell comprising:
a 3D printed first layer of housing comprising a cathode current collector;
a 3D printed second layer of housing comprising an anode current collector;
wherein a cathode material is coupled to the first layer of housing and an anode material is coupled to the second layer of housing; and

a non-solid electrolyte material deposited onto the surface of the cathode material and the anode material, wherein the first and second layers of housing are sealed to house the cathode material, the anode material and the electrolyte material.

In one embodiment, each current collector comprises an electrically conductive contact on the inside of said housing having graphite-containing conductive plastic, and said conductive contact is continuously printed onto an outer surface of the first layer or second layer.

In one embodiment, the non-solid electrolyte material comprises an aqueous gel electrolyte deposited onto the surface of the anode material and the cathode material.

In one embodiment, the cathode material comprises Lithium cobalt oxide (LCO).

In one embodiment, the anode material comprises Lithium manganese oxide (LMO).

In one embodiment, the first layer and the second layer of housing comprise a printed acrylonitrile butadiene styrene (ABS) dimensioned to engage with each other to form an airtight seal.

In one embodiment, the cathode material comprises super P (RTM) carbon, polyvinylidene fluoride (PVDF) and carbon nanotubes (CNTs).

In one embodiment, the anode material comprises super P (RTM) carbon, polyvinylidene fluoride (PVDF) and carbon nanotubes (CNTs).

In one embodiment, each current collector comprises conductive polylactic acid.

In one embodiment, the first and second layers of housing are sealed to house the cathode material, the anode material and the electrolyte material by a solvent.

In one embodiment, the cathode material is 3D printed onto the first layer of housing, the anode material is 3D printed onto the second layer of housing, and the electrolyte material is 3D printed onto the surface of the cathode material and the anode material.

In one embodiment, the first and second layers of housing are sealed to house the cathode material, the anode material and the electrolyte material by the 3D printing process.

In one embodiment, the non-solid electrolyte material comprises an organic-based electrolyte.

In one embodiment, the cathode material and the anode material comprise a composite with a conductive polymer.

In one embodiment, the cathode material comprises Lithium cobalt oxide (LCO).

In one embodiment, the anode material comprises Lithium titanate (LTO).

In one embodiment, the first layer and the second layer of housing comprise a polyether ether ketone (PEEK) plastic.

In one embodiment, the battery comprises any 3D printable shape.

In one embodiment, the battery cell is adapted to connect with other battery cells to form a modular battery cell system.

In one embodiment, the 3D printed plastic lithium ion battery system comprising a plurality of interconnected battery cells.

In another embodiment of the invention there is provided a method of manufacturing a plastic 3D printed battery cell of any 3D printable shape comprising the steps of:
3D printing a first layer of housing together with a cathode current collector;
3D printing a second layer of housing together with an anode current collector;
coupling a cathode material to the first layer of housing and an anode material to the second layer of housing;
depositing a non-solid electrolyte material onto the surface of the cathode material and the anode material; and
sealing the first and second layers of housing together to house the cathode material, the anode material and the electrolyte material.

In one embodiment, the step of coupling the cathode material to the first layer of housing and the anode material to the second layer of housing comprises drop-casting a slurry of the cathode material onto the first layer of housing and drop-casting a slurry of the anode material onto the second layer of housing.

In one embodiment, the step of depositing the non-solid electrolyte material onto the surface of the cathode material and the anode material comprises depositing an aqueous gel electrolyte onto the surface of the cathode material and the anode material.

In one embodiment, the step of sealing the first and second layers of housing together comprises hermetically sealing the first and second layers of housing together by a solvent.

In one embodiment, the step of coupling the cathode material to the first layer of housing and the anode material to the second layer of housing comprises 3D printing a formulation comprising the cathode current collector and the cathode material to the first layer of housing and 3D printing a formulation comprising the anode current collector and the anode material to the second layer of housing.

In one embodiment, the step of depositing the non-solid electrolyte material onto the surface of the cathode material and the anode material comprises 3D printing the electrolyte material onto the surface of the cathode material and the anode material.

In one embodiment, the step of sealing the first and second layers of housing together to house the cathode material, the anode material and the electrolyte material is performed by the 3D printing process.

In one embodiment, the non-solid electrolyte material comprises an organic-based electrolyte.

In one embodiment, the cathode material and the anode material comprise a is composite with a conductive organic polymer.

In one embodiment, the cathode material comprises Lithium cobalt oxide (LCO).

In one embodiment, the anode material comprises Lithium titanate (LTO).

In one embodiment, the first layer and the second layer of housing comprise a polyether ether ketone (PEEK) plastic.

According to another embodiment of the invention there is provided a plastic 3D printed battery cell comprising:
a first layer coupled with a cathode material;
a second layer coupled with an anode material;
an aqueous electrolyte gel material deposited onto the surface of the cathode material and the anode material, wherein the first and second layers are sealed to house the cathode material, the anode material and the electrolyte gel material.

One embodiment of the invention provides a combination of a customisable plastic battery cell design using 3D printing with an all-in-one gel electrolyte, enabling the cells to be built in a variety of sizes and shapes allowing, for greater integration of energy storage into electronic systems.

This embodiment of the invention provides a number of advantages over the prior art, such as:
Fully customizable shape battery cell using PLA and ABS plastics by 3D printing
No metal used in any part of the battery for the first time
Electrically conductive contacts on the inside made using graphite-containing conductive plastics, 3D printed onto the outer casing, all in one continuous step by design.
Complete solvent sealing to prevent leakage
No rusting of metallic components can occur during outside use
Lighter weight—no metal, no conductive additives to the active material, no polymer binders to composite the material—all contained with and on the plastic
Batteries can be clicked together into any conceivable geometric shape in order to increase voltage
Electrolyte is water based, no possibility of Li-ion battery catching fire
Active battery materials incorporated into conductive plastic or spray painted (choice of option depending on battery capacity requirements for a given shape/internal volume)
Active battery materials can be chosen from a gamut of available material for high voltage, high capacity or long cycle life applications (from tools and toys, to remote wireless sensors, wearable technology and gps locator ‘tiles’ etc.)
No internal heating occurs, no melting possible under use or any normal external conditions
Low thermal conductivity coating, low and high temperatures not an issue compared to metallic cased batteries
Recyclable plastic is the source material

This embodiment of the invention provides an adaptable, plastic, aqueous Li-ion battery made through implementation of 3D printing technologies with optimised gel electrolytes. The pairing of two electrode materials, Lithium Cobalt Oxide (LCO) and Lithium Manganese Oxide (LMO), which intercalate within the electrochemical window facilitated with the gel electrolyte, results in batteries which can be made which exhibit high specific capacities of 70-140 mAh/g at a range of discharge/charge rates from 0.1 C to 1 C with long term cycling exhibited.

In one embodiment the electrolyte gel material comprises an aqueous gel electrolyte deposited onto the surface of the anode and cathode material.

In one embodiment the cathode material comprises Lithium cobalt oxide (LCO).

is In one embodiment the anode material comprises Lithium manganese oxide (LMO).

In one embodiment the first layer and second layer comprise a printed acrylonitrile butadiene styrene (ABS) dimensioned to engage with each other to form an airtight seal.

In one embodiment the cathode material comprises super P (RTM) carbon, polyvinylidene fluoride (PVDF) and carbon nanotubes (CNTs).

In one embodiment the anode material comprises super P (RTM) carbon, polyvinylidene fluoride (PVDF) and carbon nanotubes (CNTs).

In one embodiment the cathode and/or anode material comprises an electrically conductive contact on the inside of said housing having graphite-containing conductive plastic, and said conductive contact is continuously printed onto an outer surface of the first layer or second layer.

In one embodiment the battery cell is adapted to connect with other battery cells to form a modular battery cell system.

In a further embodiment there is provided a method of manufacturing plastic 3D printed battery cell comprising the steps of:
depositing a first layer and printed with a cathode material;
depositing a second layer and printed with an anode material; and
depositing an aqueous electrolyte gel material onto the surface of the cathode material and the anode material, wherein the first and second layers are sealed together to house the cathode material, the anode material and the electrolyte gel material.

In one embodiment the use of a priming CV improves the subsequent cycling stability and capacities during galvanostatic charging and discharging. The optimised LiNO₃ gel electrolyte outperforms the pure liquid electrolyte and does not require the use of conventional separators. Through the use of both gel electrolytes and the customisable 3D printing technique, new shapes and structures of Li-ion batteries can be prepared for a range of applications in the electronics, wearable devices and loT industries.

In one embodiment there is provided a method for the production of plastic aqueous battery cells through the combination of conductive and insulating plastics deposited using synchronous 3D printing. The cells do not use any metal construction materials other than those of the metal-oxide active materials. The metal-free plastic construction of the battery cell means that no rusting or other environmental effects which can affect conventional cells can occur.

In one embodiment the battery electrode materials lithium cobalt oxide (LCO) and lithium manganese oxide (LMO) are used in conjunction with an optimised LiNO₃ based aqueous gel electrolyte. The resultant plastic batteries have high capacity retention after 100 cycles with specific capacities of ˜50-95 mAh/g at charge/discharge rates of between 0.1 C to 1 C. Further testing has shown the gel based batteries outperform comparable cells using conventional liquid LiNO₃ liquid electrolytes and glass fibre separators.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:—

FIG. 1 illustrates: (a) Schematic and optical images of 3D printed plastic batteries comprising an ABS shell, c-PLA conductive surfaces, LCO cathode, LMO anode and an aqueous PVP-SiO₂ based LiNO₃ gel electrolyte. (b) Primer CV for a 3D printed plastic battery with aqueous gel electrolyte.

FIG. 2 illustrates: (a) Intercalation voltage ranges of LMO and LCO with respect to SCE and Li+/Li references. (b) CV of LCO/LTO 3D printed full cell battery with EC-DEC LiPF₆ organic electrolyte highlighting the destabilisation of the cell due to plastic decomposition. CV's of three electrode flooded 5 M LiNO3 aqueous cells with (c) uncoated c-PLA/c-PLA and (d) LCO/LMO electrodes.

FIG. 3 illustrates SEM images of uncoated c-PLA and LCO/LMO coatings deposited from slurry mixtures. The insets for LCO and LMO show Raman scattering spectroscopy comparison between as-received powder and samples deposited on c-PLA substrates with EtOH based slurries. EDX mapping of the Cobalt (green) and Manganese (red) on the surface of the coated c-PLA is shown.

FIG. 4 illustrates CV's of 3D printed LCO/LMO full cells incorporating (a) 5 M LiNO₃ electrolyte with glass separator and (b) 5 M LiNO₃ gel electrolyte. The insets show CV's of uncoated c-PLA cells. (c) Comparison of charge/discharge capacities at 1C rates for 3D printed LCO/LMO cells without priming CV for a gel electrolyte, and with priming CV's for both a liquid electrolyte and gel electrolyte.

FIG. 5 illustrates (a) the 10th cycle of a LCO/gel/LMO cell for charge/discharge rates of 0.1C, 0.2C, 0.5C, 1C; and (b) the capacity over 60 cycles for the rates shown in (a); and

FIG. 6 illustrates (a) Charge/discharge profiles at 0.2 C for a 3D printed 50% thinner LCO/gel/LMO cell and corresponding specific capacities for 100 cycles. (b) Primer CV for circular “donut” shaped 3D printed LCO/gel/LMO cells. (c) Optical images showing the capability of the 3D printed LCO/gel/LMO cells for increasing voltage through series connections.

### DETAILED DESCRIPTION OF THE DRAWINGS

The invention provides a high performance 3D printed Li-ion battery designed to adapt to any consumer device including low voltage, low power, ultralong life applications. The ultralong life battery design uses materials that ensures continued operation with minimal power loss. The battery is made entirely of plastic material, ensuring the battery is completely waterproof and corrosion resistant for outside power storage as a direct solution (no casings, or connecting wires or metallic electrodes required).

The battery can be shaped to match the device profile or design, rather than the other way around, which is the current state of the art (bottleneck). All batteries today force devices to provide a void space to accommodate that shape. The invention overcomes this limitation and provides a truly shape mouldable battery deployable anywhere onto any form of device currently on the market, or yet to be designed. Such a capability is critical for loT technology (nodes, sensors, modules etc.) and for use in wearable technologies, flexible or curved consumer peripherals or products that are battery powered. Because of the shape design, the batteries are modular—capacity can be increased in thicker or higher volume batteries, incorporating more material. Similarly, voltage can be tuned by clicking multiple batteries together, as simple as clicking LEGO pieces together or a Jigsaw puzzle to make up a larger battery cell.

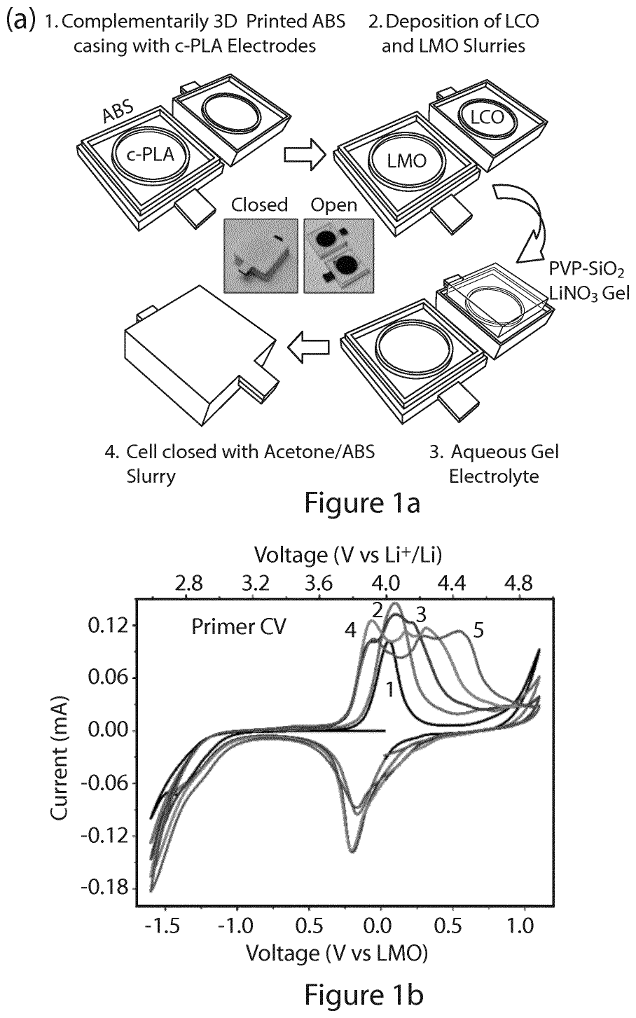

The schematic of FIG. 1 (a) shows the steps involved in the formation of a plastic 3D printed battery cell according to a first embodiment of the invention. The battery cell consists of an ABS (Acrylonitrile butadiene styrene) casing with c-PLA electrodes or current collectors that the battery material slurries, containing LCO and LMO, are dropped and dried onto. An optimised LiNO₃-based aqueous gel electrolyte is deposited onto the surface of the electrodes and the cell is closed and sealed with ABS/acetone slurry. The inset optical images show both an open and sealed cell; the ABS casing is a white colour with the black c-PLA electrodes. For full cell electrochemical testing, there is no independent reference electrode, instead the cell voltage between the positive is LCO electrode and negative LMO electrode is directly measured.

The plastic cells can be designed using a 3D computer aided design (CAD) software and printed using a MakerBot Replicator 2X or other 3D printing apparatus compatible with the plastics mentioned below. The outer casing can be printed using acrylonitrile butadiene styrene (ABS) while the conductive parts of the cell use conductive polylactic acid (c-PLA). The 3D printing settings can be adjusted to enable the two materials to be successfully printed together. After printing, the cells were put in an oven overnight at 100° C. to prepare for deposition of the active battery materials.

Lithium cobalt oxide (LCO) and Lithium manganese oxide (LMO) were purchased from Sigma-Aldrich and Fisher Scientific respectively. Slurries of the two active materials were prepared with super P (RTM) carbon, polyvinylidene fluoride (PVDF) and carbon nanotubes (CNTs) in a weight ratio to the active materials of 70:5:15:10 and mixed with ethanol. The LCO and LMO slurries were drop-cast onto the surface of the dried c-PLA and heated overnight at 100° C. Larger masses, ˜2×-3×, of the LMO anodes compared to the LCO cathodes were prepared.

It should be appreciated that while in the described embodiment above the active materials comprise LCO and LMO, any other suitable active materials could be used instead. It should further be appreciated that while LiNO₃ is used as the additive in the embodiment of the invention described above, any other suitable additive could be used, with the choice of additive being dependent on the chosen cathode material, anode material and electrolyte.

In the first embodiment of the invention, the housing and the current collectors are 3D printed, while the remaining steps in the manufacturing process do not involve the use of a 3D printer.

However, in accordance with another embodiment of the invention, the complete battery cell is manufactured by means of 3D printing. In this is embodiment of the invention, mixtures of the active cathode material and anode material are 3D printed by including the active materials within the conductive plastic formulation. The active cathode and anode materials comprise a composite of active material powder within a conductive organic polymer matrix capable of extrusion and printing from the printer nozzle. The printing of the cell is sequential. The printing of the outer casing is followed by the printing of the conductive plastic current collector. Subsequently, the active material (cathode) composite is printed followed by the non-aqueous gel. The active material composite (anode) is then printed, followed by the conductive current collector and finally the opposing outer housing, resulting in a complete 3D printed cell.

In order to enable the non-solid electrolyte to be 3D printed, the electrolyte comprises an organic based electrolyte, as an organic based electrolyte does not require any separator material within the cell, thus allowing the cell to be 3D printed sequentially in a single step.

Any plastic suitable for use with a 3D printer which is resistant to non-aqueous organic-based electrolytes may be used in this embodiment, such as for example polyether ether ketone (PEEK).

As this embodiment enables the complete printing of the battery cell in a single step using polymer based electrolytes, post printing sealing of the battery is not required, unlike the first embodiment of the invention. One advantage of the battery cell of this embodiment is that due to the use of a non-aqueous electrolyte, the cell is capable of producing higher cell voltages than the embodiment of the invention where the battery cell uses an aqueous electrolyte.

In one embodiment of the invention, the rapid printing of customized shape batteries is achieved from plastic made using injection moulding.

Thermoforming mould prototypes of a battery design are created using ABS-M30 production-grade plastic using a 3D PolyJet printer. These moulds are then subsequently used to repetitively produce injection moulded casings for the cells.

Electrochemical tests in relation to the first embodiment of the invention were performed using a BioLogic VSP Potentiostat/Galvanostat, cyclic voltammetry (CV) tests were tested at 0.5 mV/s across a variety of potential windows. Three electrode flooded cell tests were performed in a glass beaker consisting of the c-PLA electrodes with a calomel reference electrode and a 5 M LiNO₃ aqueous electrolyte. Full cell tests using 3D printed electrodes were tested using both organic and aqueous electrolytes with the cells closed after preparation using an ABS and acetone slurry. Glass fibre separators (EL-CELL 12 mm diameter, 1.55 mm thickness) were used for liquid electrolytes while an aqueous gel electrolyte was prepared for separator free cells. A 1 mol/dm solution of lithium hexafluorophosphate (LiPF₆) salts in a 1:1 (v/v) mixture of ethylene carbonate (EC) in dimethyl carbonate (DMC) was used for cell tests of organic based electrolytes while LiNO₃ was used for aqueous based electrolytes testing.

An aqueous gel electrolyte was prepared using a mixture of 5 M LiNO₃ in 2 ml DI H₂O with a 1.5:1 ratio of polyvinylpyrrolidone mw: 360 k (PVP-360 k) and fumed silica (SiO₂) (0.38845 g PVP-360 k to 0.2589 g SiO₂). The mixture was first mixed together dry prior to addition of the H₂O and stirred continuously for 4 hours at 60-80° C. The gel was allowed to cool and continuously stirred for 12 hours prior to a two hour heating and stirring at 80° C., followed by continuous stirring at 40° C. for 24 hours. After preparation, the gel was kept stirred prior to use. The varied temperature and time frames were performed to ensure sufficient mixing of the materials was performed until a gel consistency was obtained. For battery testing, ˜400 mg of gel was used per cell prior to closing with ABS/acetone slurry.

Surface morphology of the samples was examined through scanning electron microscopy (SEM) performed on a FEI Quanta 650 FEG high resolution SEM with operating voltages of 10-20 kV equipped with an Oxford Instruments X-MAX 20 large area Si diffused EDX detector. Raman scattering spectra was acquired using a QE65PRO OceanOptics spectrometer with a 50 μm width slit coupled to a microscope with a 10× objective for focusing on the surface of the is samples. A Laser Quantum GEM DPSS 532 nm wavelength laser was used for excitation.

During testing of the full LCO/gel/LMO batteries, an initial priming CV was experimentally found to be required in order to improve the effectiveness of the cell prior to galvanostatic testing. The priming CV of a LCO/gel/LMO cell is shown in FIG. 1 (b). For the priming CV, the cell was cycled five times at 0.5 mV/s in a voltage window of −1.6 V to 1.1 V. The negative scan of the five cycles has a peak centred at ˜0.17 V initially which shifts slightly over the five cycles to ˜0.21 V. At lower voltages, there are changes in the negative scan where broad peaks appear at ˜1.2 V. In contrast, the positive scan of the five cycles initially is composed of a single peak at 0.06 V which increases in current and shifts in voltage to 0.10 V. From the third cycle onwards, a number of peaks appear in the positive scan, with the final peaks in the fifth cycle at −0.05 V, 0.28 V and 0.55 V respectively. In the extents of the positive and negative scans there is the presence of both O₂ and H₂ evolution, which is a common by-product within aqueous batteries due to the smaller voltage window compared to organic electrolytes and water based electrolytes. In a sealed metal cell, the evolution of gasses can cause over pressurisation while for the plastic battery cell, which is watertight but not assumed to be 100% airtight, the pressure does not increase due to a positive pressure differential.

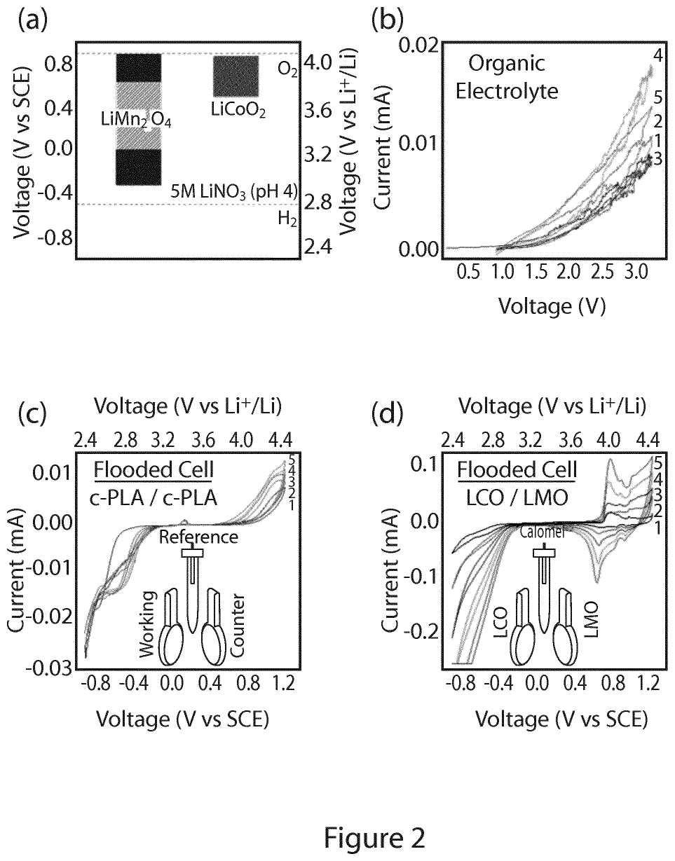

The stable intercalation voltage range of both LMO and LCO referenced to both a calomel electrode and Li+/Li is shown in FIG. 2(a). The electrochemical window in an aqueous cell is limited to lie between the voltages at which 02 and H2 evolution occurs, the range of which is indicated in FIG. 2 (a) for a pH value of 4, as found for 5M LiNO₃ electrolytes. Both LCO and LMO are cathode materials in an organic Li-ion cell, however, in an aqueous cell the smaller voltage window necessitates the use of materials which function within this window. LCO has a higher intercalation potential range than LMO which has a larger and lower voltage range as shown in FIG. 2(a), therefore for the battery cells tested in this work, LCO and LMO were chosen to function as the cathode and anode materials respectively.

An organic based battery can be prepared using the same 3D printed plastic cells with a glass separator and LiPF6 based electrolyte commonly used in literature for direct comparison to the aqueous based plastic cells shown in FIG. 1. A standard combination of a LCO cathode paired with an LTO anode electrode was used for the organic based cells instead of the aqueous LCO/LMO combination, due to the larger voltage window available. A typical CV for the organic based plastic batteries is shown in FIG. 2(b) where the cell cycles noisily with a low current which degrades as the cycling progressed. It was found that the commonly used LiPF₆-EC-DMC electrolyte detrimentally reacted with the c-PLA and ABS plastics resulting in a degradation of the electrode surfaces. Organic based electrolytes were shown to be incompatible with the ABS and PLA plastic materials. Thus, a plastic which is resistant to organic-based electrolytes should be used for the embodiment where the entire battery cell is 3D printed, such as for example polyether ether ketone (PEEK).

FIG. 2(c, d) shows the CV's and schematics for flooded (with anode and cathode 3D printed half cells dipped in the electrolyte solution) three electrode aqueous cell tests of uncoated c-PLA/c-PLA and the same electrodes coated with LCO and LMO respectively. The uncoated CV's clearly show both O₂ and H2 evolution at both extents of the voltage window. In the coated CV tests, insertion and removal peaks for the LCO is apparent above 0.4 V, while those associated with LMO are located at lower voltages close to the region where H2 evolution occurs. In the flooded cell, the pure unaltered 5 M LiNO₃ liquid electrolyte does not widen the voltage window sufficiently to allow full lithiation/delithiation of the LMO electrodes.

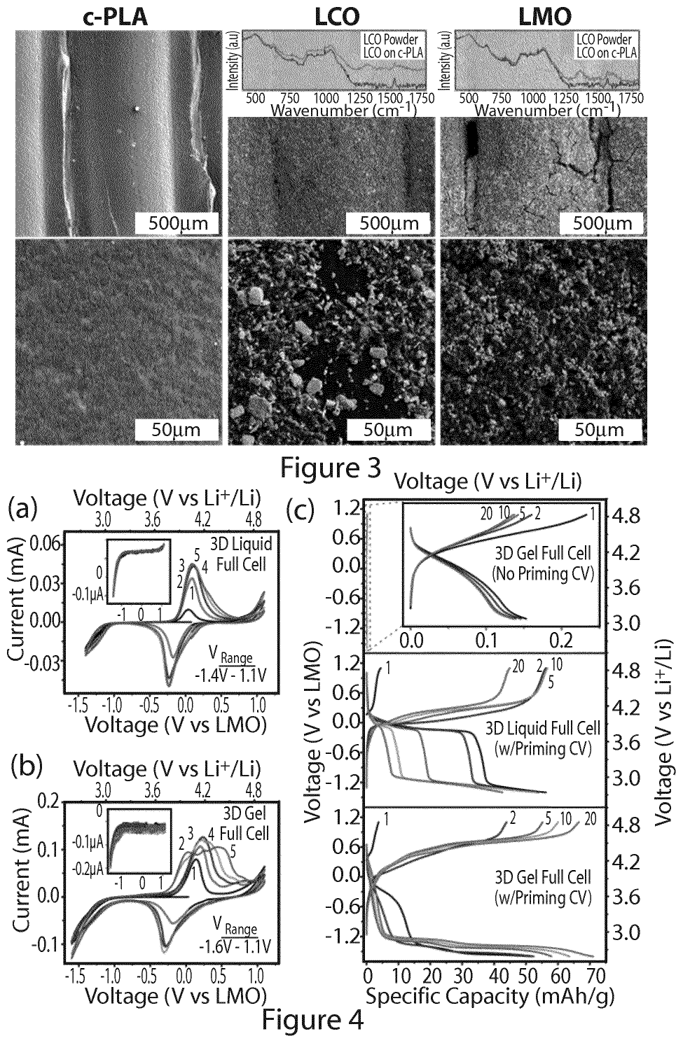

SEM images of the surface of the uncoated and LCO/LMO coated 3D printed c-PLA electrodes are shown in FIG. 3. The use of EtOH instead of other common solvents such as NMP for the electrodes slurry was required due to the chemical resistances of the c-PLA electrodes. The SEM images show that the surface of the c-PLA is uniformly coated by the active materials with the EtOH. The inset Raman scattering spectra for both the LCO and LMO show an is identical vibrational fingerprint between the as-received and slurry deposited materials. The D and G bands for carbon are apparent in the deposited materials which are attributed to the carbon used in the slurry and from the c-PLA electrode surface. The bottom SEM and elemental EDX mapping of Co and Mn in FIG. 3 show that LCO and LMO are spread throughout the surface and not confined to sparse areas. A uniform coating of active materials across the electrode facilitates good surface contact to the electrolyte gel.

FIG. 4(a) shows the CV of a 3D plastic cell with LiNO3 electrolyte and a glass fibre separator where the redox peaks for the LCO is clearly seen. As with the flooded cell tests, the peaks associated with LMO lithiation/delithiation are low in the voltage window and located within the H₂ evolution region. The inset shows the CV for an uncoated c-PLA electrode 3D cell where no peaks are apparent other than those for O₂ and H₂ evolution. The CV comparison to a 3D plastic cell with a gel electrolyte is shown in FIG. 4(b), where the change to the voltage profile is apparent as the cycles progress. The corresponding CV for an uncoated c-PLA electrode cell is shown in the inset of FIG. 4(b) demonstrating the H₂ evolution during cycling of the gel electrolyte. The change in the CV profile is attributed to the effect of the LiNO₃ gel electrolyte on widening of the voltage window, allowing the LMO material to have a larger effect on the cycling. It is known that the effect of electrolyte composition, pH and kinetic effects can each widen the electrochemical window of aqueous electrolytes; therefore the effect of the LiNO₃ gel allows for a sufficient increase in the range allowing for the increased LMO contribution to the battery cycling. The higher discharge vs. charge specific capacities of the gel to the liquid electrolyte is attributed to the effect that the H₂ evolution has on the cycling, due to the proximity of the LMO intercalation potentials to the lower voltage limit.

In order to obtain the highest capacities from the 3D printed plastic battery cells the use of priming CV's, prior to galvanostatic testing, should be implemented. FIG. 4 (c) compares the 1st, 2nd, 5th, 10th and 20th charge/discharge cycle at 1C rates of three 3D plastic cells consisting of; LiNO₃ gel electrolyte cell without a priming CV, LiNO₃ liquid electrolyte cell with priming CV and a LiNO₃ is gel electrolyte cell with priming CV. The gel electrolyte based cell without an initial priming CV has a low charge/discharge capacity due to rapid cycling of the battery. The primed liquid electrolyte cell shows good charge/discharge capacity retention per cycle, however, the overall capacities between the 1st and 20th cycles decrease with significant changes to the discharge profile. The primed gel electrolyte tests show a consistent charge/discharge voltage profile after the first two cycles with high capacities that continue to increase at the 20th cycle. The combination of the priming CV and use of an optimised gel electrolyte is shown to produce 3D plastic cells with the best performing charge/discharge characteristics.

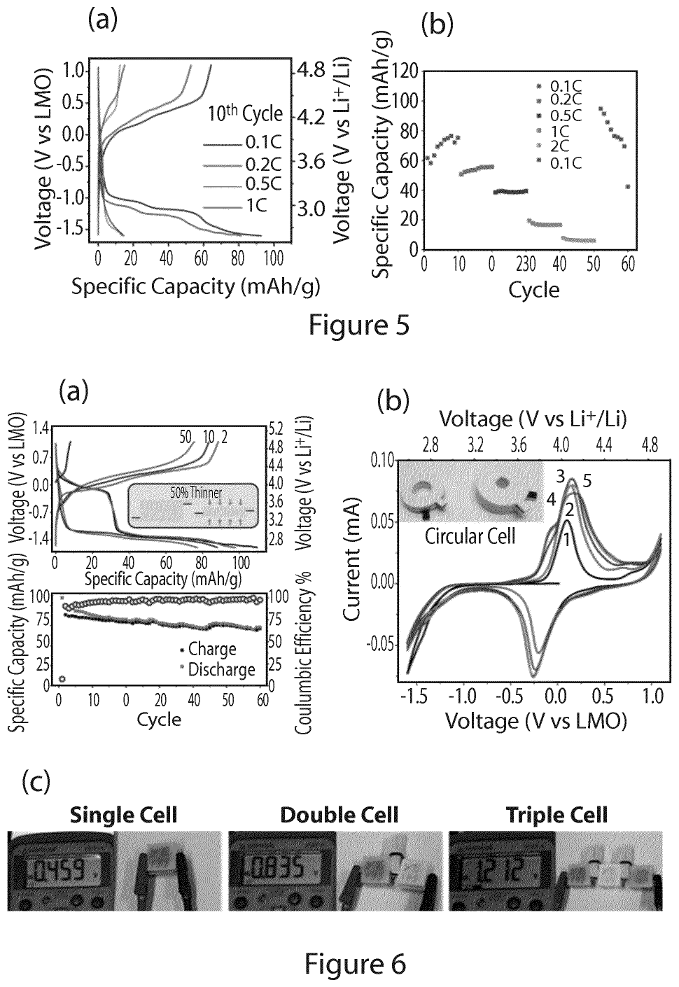

The cycling stability of the 3D gel electrolyte based plastic cells was also examined to determine the effect of a specific current on the response of a 3D printed plastic battery. The LCO/gel/LMO cell was cycled at charge/discharge rates of 0.1C, 0.2C, 0.5C, 1C. The 10th cycle at each rate is shown in FIG. 5 (a). Higher discharge capacities occur at low current rates. The capacity recovers upon reapplication of 0.1C rate to a final average discharge capacity of ˜70 mAh/g after 60 cycles (FIG. 5 (b)). The overall trend of the charge capacities matches that of the discharge with lower values.

As discussed above, one factor in the high capacity of the LCO/gel/LMO battery cell is attributed to the larger electrochemical window >1.23 V made possible by the gel electrolyte. The rate tests demonstrate that the 3D LCO/gel/LMO plastic cells can be employed effectively for low power applications, due to the capacity retention at low charge/discharge rates. In the tests shown in previous Figures, the cells are able to retain their capacities as the initial rate primed each successive cycle, resulting in increasing of capacities with each cycle until a stable value is reached.

The adaptive capability of the 3D printing technique combined with aqueous gel electrolytes for batteries is unique and makes the design simple and effective. In FIG. 6, the adaptability of the 3D printing process for the formation of all-plastic cells is demonstrated in various ways. The long term charge and is discharge efficiency of a plastic cell printed 50% thinner is shown in FIG. 6 (a). The thinner cell was cycled at 0.2 C for 100 cycles with the charge/discharge specific capacities remaining above 70 mAh/g with a final value of 78 and 80 mAh/g respectively after the 100 cycles. The thinner cell uses less gel electrolyte, ˜2.5× less, to the first cells described in FIG. 1. The smaller cell demonstrates the adaptability of the technique for both increasing the efficiency and decreasing the footprint of the 3D printed gel cells through simple modification made feasible with the 3D building technique.

A major benefit of the 3D printing technique for the formation of the battery cells of the present invention is the range of architectures which can be produced and tested rapidly. Cells can be made with radically different shapes and dimensions, from common rectangular and circular architectures to more complex shapes, as long as the shape in question can be designed using appropriate 3D design software. The battery can in principle, be matched to the wearable, peripheral or device design and function, rather than the other way round. FIG. 6(b) shows a primer CV and associated optical image of a circular “donut” shaped battery cell. The primer CV demonstrates the consistent redox behaviour for the LCO as observed in square-shaped cells previously described, while the cell shape is different.

In FIG. 6(c) the voltages of charged LCO/gel/LMO battery cells connected in series with single, double and triple cells is shown at ˜50% state of charge. The voltage increases with each subsequent cell connected in series. FIG. 6 (c) demonstrates the capability of the battery cells to be “clicked” together to produce higher voltages, preferably in a ‘snap fit’ type connection. This can also be achieved by designing a battery with multiple cells in series, bipolar or parallel architectures. The capability of the 3D printed LCO/gel/LMO battery cells, according to the invention, for the scalability of lightweight and adaptable battery designs will be of significant usefulness to consumer electronics, medical devices, wearables and modern loT applications.

It will be appreciated that the invention can be employed in telecommunication applications, such as:

1) Off-grid small cell deployment (that needs remote power sources) for 5G

2) Long lifetime maintenance-free deployment of Machine-to-Machine (M2M) and wireless sensor communication platforms that is critical for the Internet of Things (IOT).

3) any electronic device that requires a battery or a rechargeable battery, from wearables such as glass, smartwatches, and clothing and peripherals, to personal computing, phone and related technologies.

It will be further appreciated that the battery cell hereinbefore described has applications in the field of wearable or small size, portable medical devices, implantable defibrillator batteries, sensors for office block room environment controls, and the agri-tech sector.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

is The invention is not limited to the embodiments hereinbefore described but may be varied in both construction and detail.

1. A plastic 3D printed battery cell comprising:
A 3D printed first layer of housing comprising a cathode current collector;
A 3D printed second layer of housing comprising an anode current collector;
wherein a cathode material is coupled to the first layer of housing and an anode material is coupled to the second layer of housing; and
a non-solid electrolyte material deposited onto the surface of the cathode material and the anode material, wherein the first and second layers of housing are sealed to house the cathode material, the anode material and the electrolyte material.

2. The battery cell of claim 1, wherein each current collector comprises an electrically conductive contact on the inside of said housing having graphite-containing conductive plastic, and said conductive contact is continuously printed onto an outer surface of the first layer or second layer.

3. The battery cell of claim 1, wherein the non-solid electrolyte material comprises an aqueous gel electrolyte deposited onto the surface of the anode material and the cathode material.

4. The battery cell of claim 1, wherein the anode material or the cathode material comprise a water or solvent processable material.

5. The battery cell of claim 4, wherein the cathode material comprises Lithium cobalt oxide (LCO) and/or wherein the anode material comprises Lithium manganese oxide (LMO).

6. The battery cell of claim 1, wherein the first layer and the second layer of housing comprise a printed acrylonitrile butadiene styrene (ABS) dimensioned to engage with each other to form an airtight seal.

7. The battery cell of claim 1, wherein the cathode material and/or the anode material comprises super P (RTM) carbon, polyvinylidene fluoride (PVDF) and carbon nanotubes (CNTs).

8. (canceled)

9. The battery cell of claim 1, wherein each current collector comprises conductive polyactic acid.

10. The battery cell of claim 1, wherein the first and second layers of housing are sealed to house the cathode material, the anode material and the electrolyte material by a solvent.

11. The battery cell of claim 1, wherein the cathode material is 3D printed onto the first layer of housing, the anode material is 3D printed onto the second layer of housing, and the electrolyte material is 3D printed onto the surface of the cathode material and the anode material.

12. (canceled)

13. The battery cell of claim 11, wherein the non-solid electrolyte cathode material comprises an organic-based electrolyte.

14. The battery cell of claims 11, wherein the cathode material and the anode material comprise a composite with a conductive polymer.

15. The battery cell of claim 14, wherein the cathode material comprises Lithium cobalt oxide (LCO) and/or wherein the anode material comprises Lithium titanate (LTO).

16.-20. (canceled)

21. A method of manufacturing a plastic 3D printed battery cell of any 3D printable shape consisting the steps of:
3D printing a first layer of housing together with a cathode current collector;
3D printing a second layer of housing together with an anode current collector;
coupling a cathode material to the first layer of housing and an anode material to the second layer of housing;
depositing a non-solid electrolyte material onto the surface of the cathode material and the anode material; and
sealing the first and second layers of housing together to house the cathode material, the anode material and the electrolyte material.

22. The method of claim 21, wherein the step of coupling the cathode material to the firs layer of housing and the anode material to the second layer of housing comprises drop-casting a slurry of the cathode material onto the first layer of housing and drop-casting a slurry of the anode material onto the second layer of housing.

23. The method of claim 21, wherein the step of depositing the non-solid electrolyte material onto the surface of the cathode material and the anode material comprises depositing an aqueous gel electrolyte onto the surface of the cathode material and the anode material.

24. The method of claim 21, wherein the step of sealing the first and second layers of housing together comprises hermetically sealing the first and second layers of housing together by a solvent.

25. The method of claim 21, wherein the step of coupling the cathode material to the first layer of housing and the anode material to the second layer of housing comprises 3D printing a formulation comprising the cathode current collector and the cathode material to the first layer of housing and 3D printing a formulation comprising the anode current collector and the anode material to the second layer of housing.

26. The method of claim 25, wherein the step of depositing the non-solid electrolyte material onto the surface of the cathode material and the anode material comprises 3D printing the electrolyte material onto the surface of the cathode material and the anode material.

27. The method of claim 26, wherein the step of sealing the first and second layers of housing together to house the cathode material, the anode material and the electrolyte material is performed by the 3D printing process.

28.-32. (canceled)
